(19) United States
(12) Patent Application Publication
(10) Pub. No.: US 2007/0143470 A1
(43) Pub. Date: Jun. 21, 2007

(54) Facilitating integrated web and telecommunication services with collaborating web and telecommunication clients

(75) Inventor: Dany Sylvain, Gatineau (CA)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 11/312,675

(22) Filed: Dec. 20, 2005

(51) Int. Cl. G06F 15/173

(52) U.S. Cl. 709/224

(57) ABSTRACT

The present invention configures web clients, which support web services over a web services network, to obtain telecommunication information from an associated telecommunication client. The web client will then provide the telecommunication information to a web server in association with a web service, which requires the telecommunication information to use a telecommunication service provided by a telecommunication network. Upon receipt of the telecommunication information from the web client, the web server may invoke a telecommunication service to be provided by the telecommunication network using the telecommunication information.

### FIELD OF THE INVENTION

The present invention relates to communications, and in particular to allowing associated telecommunication and web clients to interact with one other to facilitate greater interaction between web and telecommunication services.

### BACKGROUND OF THE INVENTION

As the Internet and web-based services have evolved, there has been an increasing effort to integrate certain types of web services with telecommunication services. Such integration will allow web services to request or use telecommunication services, and vice versa. For example, a web client may allow a user to click a link or icon to establish a call between the user's telecommunication terminal and a third party. Although there are a wealth of available telecommunication services ranging from establishing voice calls and other communication sessions to authentication and billing services, web service providers are generally unable to obtain sufficient information about the telecommunication terminal and the supporting networks to take advantage of many of the available telecommunication services.

For those telecommunication services that the web services can use, the web service providers need to be provided with address or capability information for the telecommunication terminal and the supporting telecommunication network. In most instances, the address or capability information cannot be obtained from the telecommunication network by the web service providers and must be manually provisioned. Once provisioned, the web services can send basic commands to establish a connection, deliver a message, or obtain a location. There is very limited opportunity for full interaction or cooperation between the telecommunication service providers and web service providers to allow the web service providers to take full advantage of the infrastructure and services of the telecommunication network.

Accordingly, there is a need for a technique to facilitate greater interaction between web and telecommunication services. In particular, there is a need for an efficient and effective technique to provide address, capability, or other information for a communication terminal or network to a web service provider, which can use the telecommunication information to initiate a telecommunication service. There is a further need to provide the address and capability information in an automated fashion.

### SUMMARY OF THE INVENTION

The present invention configures web clients, which support web services over a web services network, to obtain telecommunication information from an associated telecommunication client. The web client will then provide the telecommunication information to a web server in association with a web service, which requires the telecommunication information to use a telecommunication service provided by a telecommunication network. The telecommunication information is associated with the telecommunication network and is specific to a user or the communication client associated with the user. The telecommunication information may relate to addresses, capabilities, or credentials associated with the user or the telecommunication client. Upon receipt of the telecommunication information from the web client, the web server may invoke a telecommunication service to be provided by the telecommunication network using the telecommunication information. The telecommunication service may involve the telecommunication client, with may be integrated into the same or different communication terminal as the web client. The telecommunication services may be any type of service provided by the telecommunication network and need the telecommunication information to be invoked. The services may range from establishing to and controlling communication sessions in the telecommunication network to providing authentication, policy enforcement, and billing services.

In another embodiment of the invention, telecommunication clients, which support telecommunication services over the telecommunication network, are configured to obtain web services information from an associated web client. The telecommunication client will then provide the web services information to a web server in association with a telecommunication service. The telecommunication service may require the web services information to use a web service provided by the web services network. The web services information is associated with the web services network and may be specific to a user or the communication client associated with the user. Upon receipt of the web services information from the telecommunication client, an entity on the telecommunication network may invoke a web service to be provided by the web services network using the web services information.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a communication environment according to the prior art.

FIG. 2 is a communication environment supporting a communication terminal according to one embodiment of the present invention.

FIGS. 3A-3C are a communication flow illustrating how a web service to establish a video session for delivering movie content will invoke telecom services to provide authentication, enforce policies, provide billing, and establish the session for delivering the movie content to a communication client according to one embodiment of the present invention.

FIG. 4 is a communication environment supporting a web terminal and a telecom terminal according to a second embodiment of the present invention.

FIG. 5 is a block representation of a web server according to one embodiment of the present invention.

FIG. 6 is a block representation of a communication terminal according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention facilitates interaction between web and telecommunication services by allowing respective web and telecommunication clients to exchange user-specific data pertaining to their addresses, capabilities, or credentials. In one embodiment, the telecommunication client will have access to user-specific data, such as network or application layer addresses, capabilities, or credentials associated with the telecommunication client. The telecommunication client will provide the user-specific data to a web client associated with the user. The web client can then provide the user-specific data, which is associated with the telecommunication client, to a web server that will initiate a telecommunication service for the user involving the telecommunication network. Prior to delving into the details of the present invention, an overview of a traditional communication environment where interaction between the web and telecommunication networks is limited is provided.

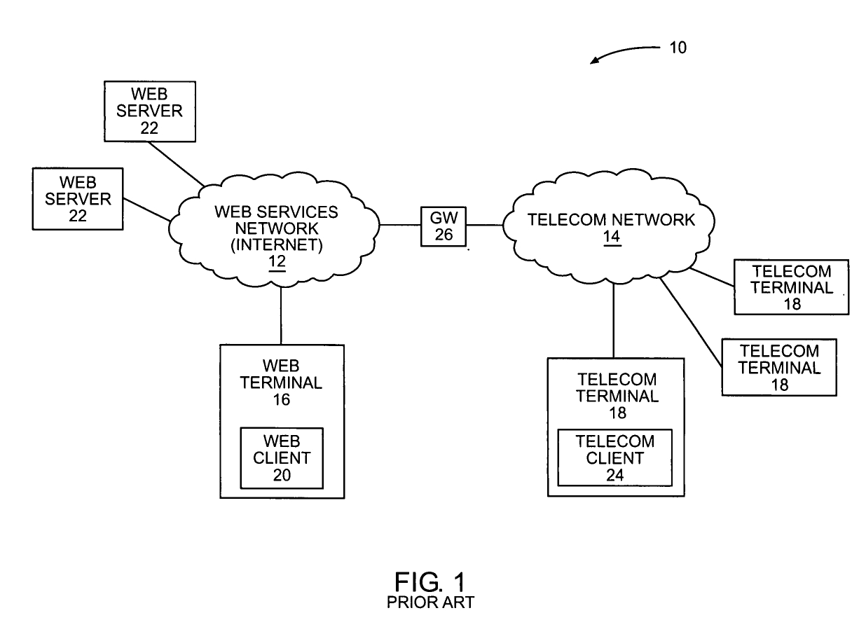

With reference to FIG. 1, a communication environment 10 is provided wherein a web services network 12, such as the Internet, for porting web services is associated with a telecommunication (telecom) network 14. Notably, the web services network 12 and the telecom network 14 may be supported in part or in whole over a common infrastructure. The telecom network 14 may represent one or any combination of the following networks: the public switched telephone network (PSTN) or a packet network. The web services network 12 is generally afforded by a core packet network, wherein access may be provided through various types of wired or wireless access networks. Accordingly, the web services network 12 represents a network capable of supporting web services, and the telecom network 14 represents a network capable of providing telecommunication services. Although these networks may share select infrastructure, their functionalities are substantially isolated from one another.

As illustrated, web terminals 16 are capable of interacting with the web services network 12 to take advantage of web services, and telecom terminals 18 are capable of taking advantage of telecommunication services, such as initiating, establishing, and participating in voice calls. The web terminals 16 will include a web client 20, which is capable of interacting with one more web servers 22 to initiate and participate in various types of web services. The web client 20 may represent a browser, email client, database access client, or any other type of client configured to invoke web services over the web services network 12. The web terminal 16 may be a mobile terminal, personal computer, or personal digital assistant including a web client 20. The telecom terminal 18 will include a telecom client 24 to facilitate interaction with the telecom network 14 to take advantage of telecommunication services provided by the telecom network 14. The telecom terminal 18 may represent a Voice over Packet (VoP) telephone or telecom-capable personal computer or personal digital assistant.

Traditionally, interaction between the web services network 12 and the telecom network 14 has been unidirectional. When interaction takes place, the web server 22 will generally send a one-way command to the telecom network 14 to initiate a specific function. The command may instruct the telecom network 14 to establish a connection between multiple telecom clients 24, send a message to a telecom terminal 18 via the telecom network 14, or obtain location information. Unfortunately, the abilities of the web services network 12 and the telecom network 14 are substantially limited. As such, the web services network 12 is limited in being able to obtain from the telecom network 14 information that would allow the web services network 12 to better take advantage of telecommunication services provided by the telecom network 14. Without pre-provisioning, which is generally a manual effort, the web services network 12 is unable to obtain telecom network information, such as addresses, capabilities, and credentials, which are necessary to take greater advantage of the services provided by the telecom network 14. A gateway 26 is provided between the web services network 12 and the telecom network 14 to facilitate signaling between the networks. The gateway 26 may provide the requisite signaling adaptation or interpretation such that messages from the web services network 12 are converted to appropriate messages or instructions within the telecom network 14, and vice versa.

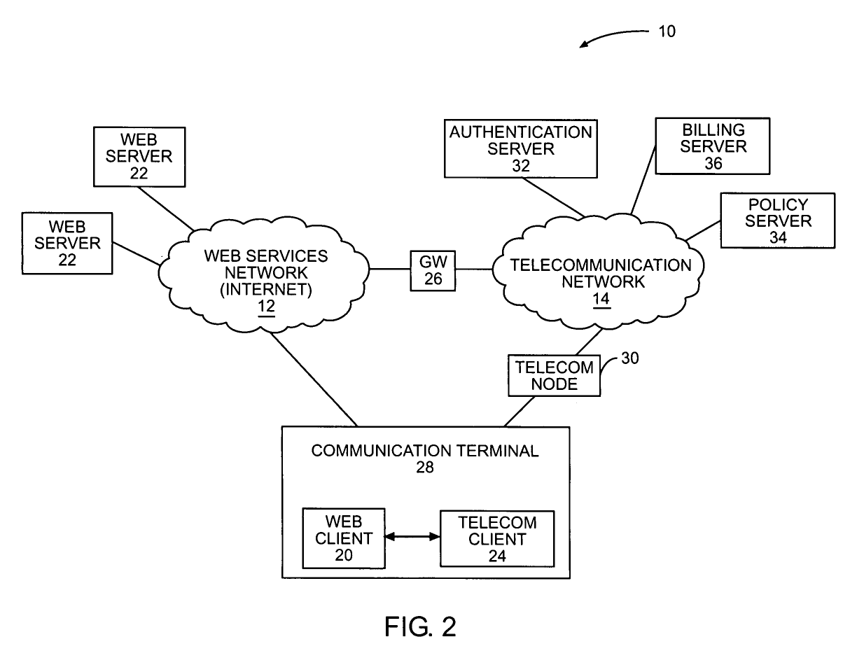

With reference to FIG. 2, a communication environment 10 is illustrated according to one embodiment of the present invention. In this embodiment, a communication terminal 28 is provided with both a web client 20 and a telecom client 24. The communication terminal 28 may gain access to the telecom network 14 via a telecom node 30, which may represent a cable or digital subscriber line (DSL) modem. The telecom client 24 will have or be able to obtain telecom information, such as the address, capabilities, and credential information associated with the communication terminal 28, and provide the telecom information to the web client 20, which may provide the telecom information to one of the web servers 22 in association with a web service. The web server 22 will then be able to use the telecom information to take advantage of telecom services supported by the telecommunication network 14. In another embodiment, the web client 20 may be able to obtain web-specific information and provide it to the telecom client 24, which will be able to provide the web information to an entity on the telecommunication network 14, which will engage web services based on the web information. The telecom information and the web information that are exchanged between the web client 20 and the telecom client 24 are generally user-specific, which would include being specific to the communication terminal 28.

In addition to initiating, establishing, and controlling communication sessions, the telecommunication network services may relate to any potential service provided predominantly by the infrastructure of the telecommunication network 14. As illustrated, the telecommunication network 14 may have one or more of the following: an authentication server 32, a policy server 34, and a billing server 36. The authentication server 32 may be used to authenticate a user, the telecom client 24, or the communication terminal 28 for select services. With the present invention, the authentication service that is normally provided only for telecom services may be used for web services. Similarly, the policy server 34 may be used to control bandwidth and resources provided over the telecommunication network 14, as well as the ability to establish communication sessions to or from different entities or areas. When using the policy server 34 for web services, different quality of service levels may be provided for different subscription levels, users, and communication terminals 28. The billing server 36 may allow web services to take advantage of the significant billing infrastructure provided by the telecommunication network 14. As such, certain web services may be billed in conjunction with other telecommunication services or in an independent fashion.

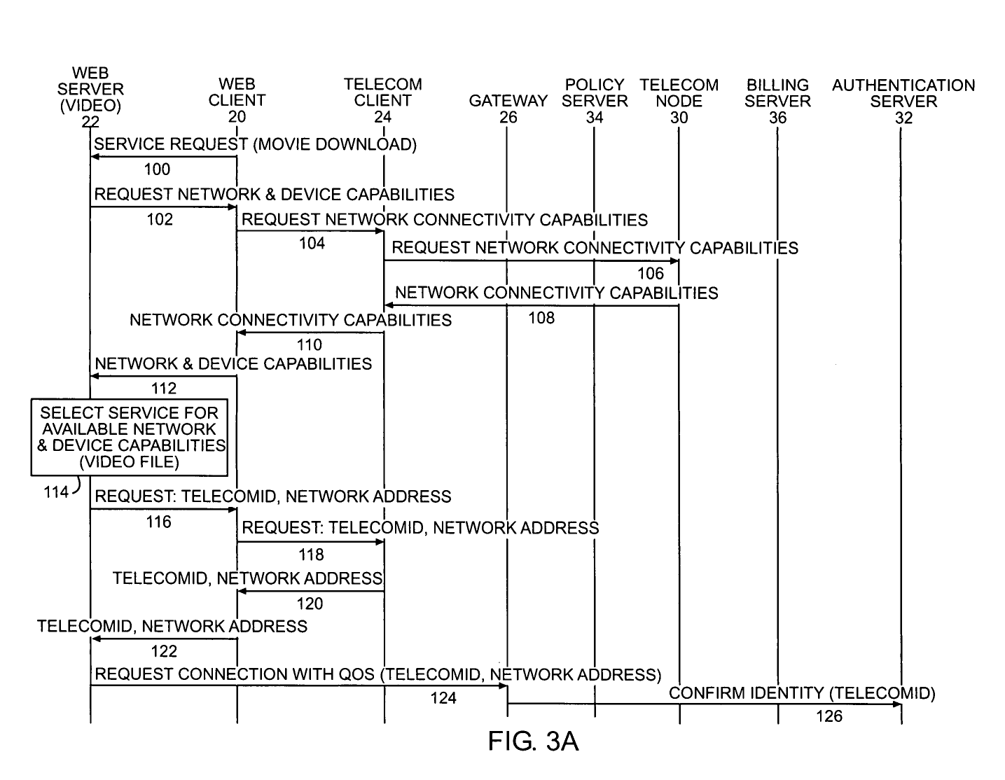

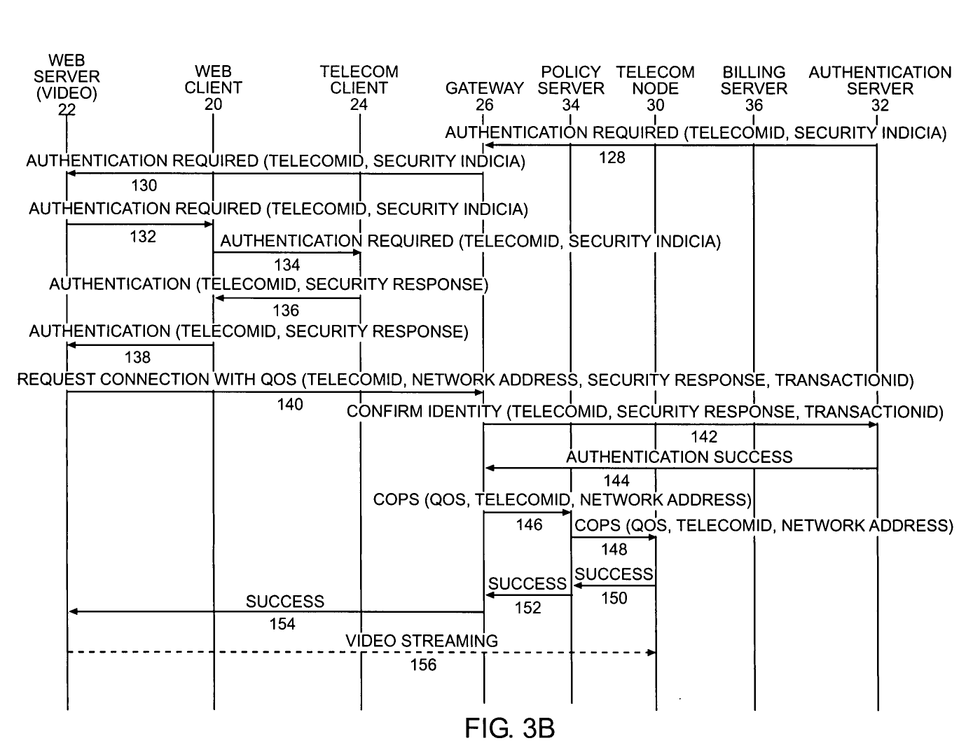

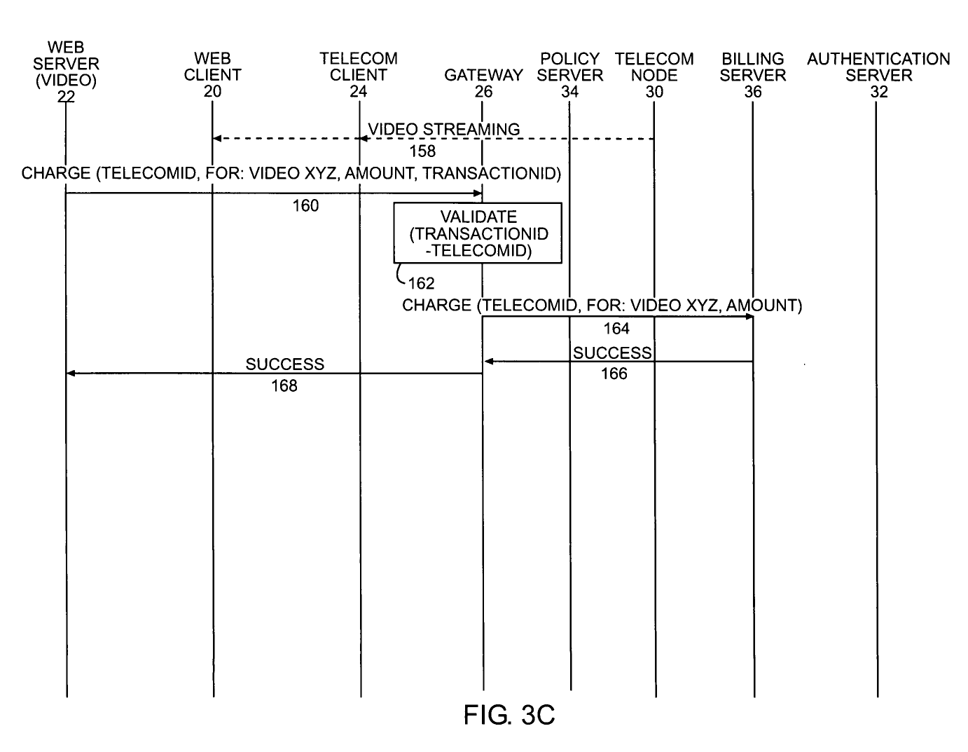

With the present invention, the telecom information passed to the web client 20 from the telecom client 24 allows a web server 22 to invoke one or more telecom services in association with a given web service. With reference to FIGS. 3A-3C, a communication flow illustrates how a web service to establish a video session for delivering movie content will invoke telecom services to provide authentication, enforce policies, provide billing, and establish the session for delivering the movie content to the communication client 28. The movie content is delivered from a web server 22 via the telecom node 30 of the telecommunication network 14.

Initially, assume the web client 20 of the communication terminal 28 sends a Service Request to download a movie to the web server 22, which provides a video web service (step 100). To download the movie, the web server 22 may send a request for network and device capabilities back to the web client 20 (step 102). The web client 20 will request network connectivity capabilities for the telecommunication network 14 from the telecom client 24 (step 104). If the network connectivity capabilities are not already known, the telecom client 24 may send a request to obtain network connectivity capabilities to the telecom node 30 (step 106), which will determine the network connectivity capabilities and provide them back to the telecom client 24 (step 108). The telecom client 24 will then send the network connectivity capabilities to the web client 20 (step 110), which will then forward the network capabilities along with the device capabilities associated with the communication client 28 to the web server 22 (step 112).

Based on the network and device capabilities provided by the web client 20, the web server 22 may select an appropriate service based on these capabilities (step 114). In this example, the service may be an appropriate video file, compression rate, data rate, and the like, which are appropriate or available in light of the network and device capabilities. Since the movie is to be downloaded to the communication terminal 28 through the telecommunication network 14, the web server 22 may need addressing information for delivery of the movie content. In this example, the web server 22 will need a telecommunication Identification (telecomID) and a network address. The telecom ID will correspond to an application layer ID, such as a directory number, user address, or appropriate uniform resource identifier. The network address may correspond to an Internet Protocol (IP) address, port number, Ethernet address, asynchronous transfer mode address, or the like. The telecom ID generally corresponds to an application layer identification, wherein the network address may correspond to Layer 1 or Layer 2 addressing.

Since the web server 22 needs the telecom ID and the network address for the communication terminal 28, the web server 22 may send a request to the web client 20 requesting the telecom ID and network address (step 116). The web client 20 will then request the telecom ID and network address from the telecom client 24 (step 118), which will provide the telecom ID and network address (telecom information) to the web client 20 (step 120), which will forward the telecom information to the web server 22 (step 122).

Armed with the telecom ID and network address, the web server 22 may initiate a connection to the communication terminal 28 via the telecommunication network 14. To request the connection, the web server 22 may send an appropriate request with the desired quality of service (QoS), telecom address, and network address, to the gateway 26 (step 124), which will attempt to authenticate the request with the authentication server 32. Accordingly, the gateway 26 will send a message to confirm the identity associated with the telecom ID to the authentication server 32 (step 126). In this example, the authentication server 32 may determine that full authentication is required for the telecom ID, and thus will send a message to the gateway 26 indicating that authentication is required (step 128). The message sent to the gateway 26 will identify the telecom ID as well as provide security indicia to assist in the authentication process. The gateway 26 will then send a corresponding message indicating that authentication is required back to the web server 22 (step 130).

The web server 22 will send a message to the web client 20 indicating that authentication is required, and will provide the telecom ID and the security indicia provided by the authentication server 32 (step 132). The web client 20 will then send a message indicating that authentication is required to the telecom client 24 (step 134). The telecom client 24 will process the security indicia to create a security response. For example, the security indicia may be encrypted with a particular key known to both the telecom client 24 and the authentication server 32. The telecom client 24 will then send an authentication message including the telecom ID and the security response to the web client 20 (step 136), which will send an authentication message including the telecom ID and the security response to the web server 22 (step 138). The web server 22 will attempt to request a connection with the desired quality of service for a second time by sending an appropriate request including the telecom ID, the network address, the security response, and perhaps a transaction ID associated with the requested service, to the gateway 26 (step 140). The gateway 26 will send a Confirm Identity message with the telecom ID, security response, and transaction ID, to the authentication server 32 (step 142), which will process the security response to confirm authentication. Assuming authentication is approved, an Authentication Success message is provided back to the gateway 26 (step 144).

Since the connection request identified a desired quality of service level, the gateway 26 may interact with the policy server 34 to confirm that the quality of service level requested is available for the telecom ID or network address associated with the communication client 28. Accordingly, the gateway 26 may send a message to the policy server 34 to confirm that a service with the desired quality of service is available for the communication terminal 28 associated with the telecom ID and the network address (step 146). The message may be sent using the Common Open Policy Service (COPS) protocol, as illustrated. The policy server 34 may send a similar COPS message to the telecom node 30 or other network entity supporting the telecom client 24 of the communication terminal 28 to make sure that the requested service can be delivered with the desired quality of service (step 148). Assuming that the service can be delivered given the desired quality of service level, and that the appropriate resources are available, the telecom node 30 may send a Success message back to the policy server 34 (step 150), which will send a Success message to the gateway 26 (step 152). The gateway 26 can then send a corresponding Success message back to the web server 22 (step 154).

At this point, the web server 22 will recognize that the communication terminal 28 has been authenticated and approved using telecom-based authentication and policy services. Video streaming for the requested movie service may now commence, wherein the delivery path for the video streaming will start at the web server 22 and move through the web services network 12, and through the telecom network 14 to the telecom node 30 (step 156). It will then be delivered to the communication terminal 28 (step 158). The video streaming will be received via the telecom client 24, and will be provided to the web client 20, if necessary or desired.

For billing, the web server 22 may provide a Charge message to the gateway 26 identifying the telecom ID, the video service requested, an amount associated with the video service to be charged to the user's account, and the transaction ID (step 160). The gateway 26 may validate the charge by comparing the transaction ID and telecom ID provided in the Charge message with that received in prior communications (step 162). If the charge is validated, the gateway 26 will send a Charge message to the billing server 36 (step 164), wherein a telecom billing service will account for the video-based web service, which was originally requested by the web client 20 via the web services network 12. The billing server 36 will send a Success message back to the gateway 26 (step 166), which will be forwarded to the web server 22 (step 168).

From the above, the present invention provides an efficient and effective technique for delivering telecom information necessary for taking advantage of telecom services to a web client 20 from a telecom client 24, which can readily obtain the telecom information. The web client 20 can provide the telecom information to an appropriate web services provider, which can use the telecom information to engage any number of telecom services where the telecom information is required to initiate these services. Alternatively, the web client 20 may be able to obtain web information specific to the user of the communication terminal 28 and provide the web information to a telecom client 24. The telecom client 24 can then provide the web information to a telecom service provider, which may use the web information to engage a web service, wherein the web information is required.

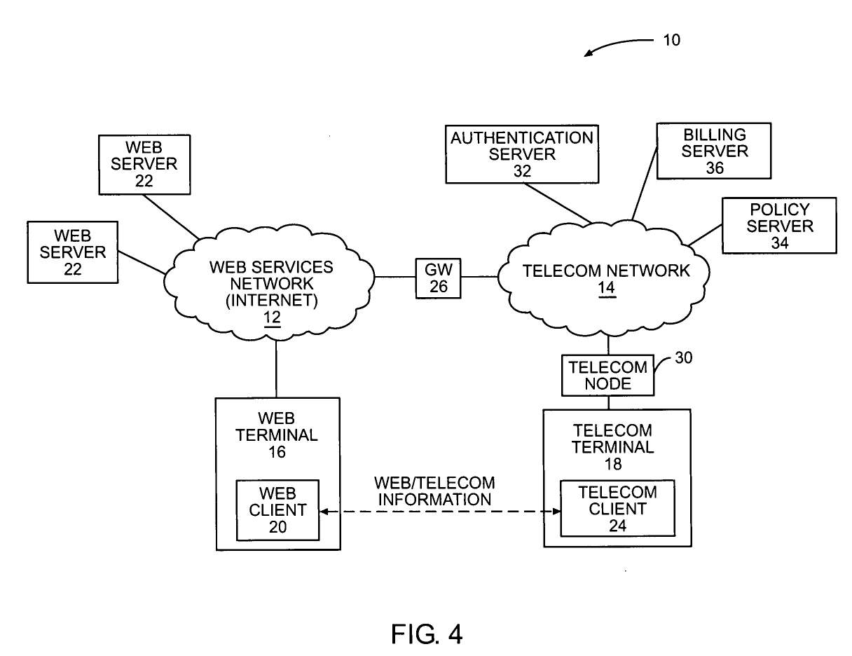

With reference to FIG. 4, the web client 20 and the telecom client 24 may be implemented in different entities, such as the web terminal 16 and the telecom terminal 18, respectively. The functionality described above remains the same, wherein the web client 20 and the telecom client 24 will communicate with each other to exchange telecom information or web information. The telecom and web information may be exchanged directly through wired or wireless means, or indirectly through wired or wireless means via the web services network 12 and the telecom network 14. The concepts of the present invention remain the same, wherein the web client 20 and the telecom client 24 are configured to obtain and provide each other with information pertaining to their supporting networks.

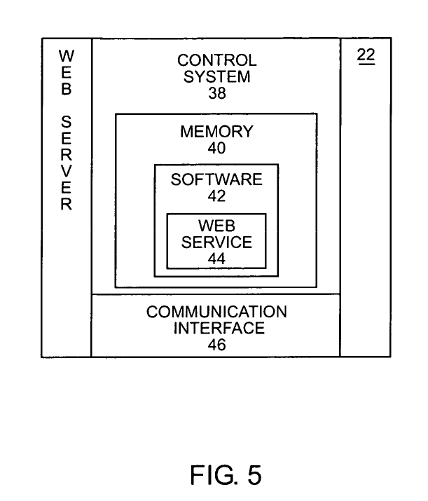

With reference to FIG. 5, a web server 22 is illustrated according to one embodiment of the present invention. The web server 22 may include a control system 38 having sufficient memory 40 with the requisite software 42 to operate as described above. In particular, the software 42 may provide a web service 44, which will retrieve telecom information from a web client 20 and engage a telecom service using the telecom information. The control system 38 may also be associated with a communication interface 46, to facilitate communications over the web services network 12 with the web terminal 16, communication terminal 28, gateway 26, or other appropriate web services network entity in a direct or indirect fashion.

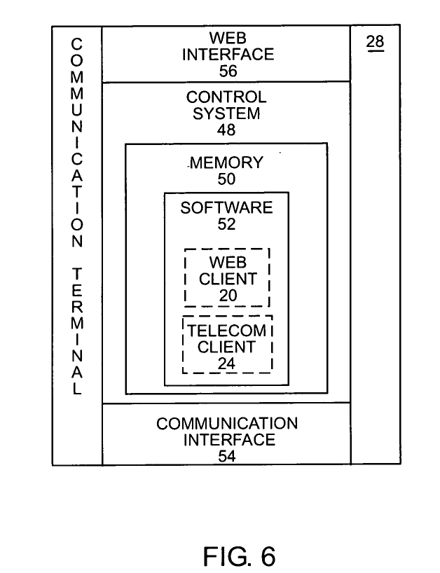

With reference to FIG. 6, a block representation of a communication terminal 28 is provided. The communication terminal 28 will include a control system 48 having sufficient memory 50 for the requisite software 52 to operate as described above. The software 52 of the communication terminal 28 may include a web client 20, telecom client 24, or both to effectively represent the web terminal 16, telecom terminal 18, or communication terminal 28, respectively. Regardless of configuration, the control system 48 will support direct or indirect communications between the web client 20 and the telecom client 24, whether they are internally provided or provided on an associated web terminal 16 or telecom terminal 18. The control system 48 will also be associated with a communication interface 54 to facilitate communications over the web services network 12, telecom network 14, or both, as well as a user interface 56 to facilitate user interaction and support audio, video, and voice applications, as desired.

Those skilled in the art will recognize improvements and modifications to the preferred embodiments of the present invention. All such improvements and modifications are considered within the scope of the concepts disclosed herein and the claims that follow.

What is claimed is:

1. A communication terminal comprising:
a user interface;
at least one communication interface; and
a control system associated with the user interface and the at least one communication interface and providing a web client adapted to:
interact with a web server to invoke web services via a web services network;
receive telecommunication information from a telecommunication client; and
provide the telecommunication information to the web server in association with a web service, which requires the telecommunication information to use a telecommunication service provided by a telecommunication network.

2. The communication terminal of claim 1 wherein the telecommunication information is associated with the telecommunication network and is specific to a user or a communication client associated with the user.

3. The communication terminal of claim 2 wherein the telecommunication information comprises address indicia associated with the communication client.

4. The communication terminal of claim 3 wherein the address indicia is a telecommunication identifier for applications supported by the telecommunication network.

5. The communication terminal of claim 3 wherein the address indicia is a network address of the communication terminal.

6. The communication terminal of claim 2 wherein the telecommunication information bears on capabilities of the telecommunication client or telecommunication network to facilitate communications with the telecommunication network.

7. The communication terminal of claim 2 wherein the telecommunication information bears on credentials of the telecommunication client or the telecommunication network.

8. The communication terminal of claim 1 wherein the web client is further adapted to request the telecommunication information from the telecommunication client.

9. The communication terminal of claim 8 wherein the web client is further adapted to receive a request for the telecommunication information from the web server in association with the web service.

10. The communication terminal of claim 1 wherein the telecommunication client is provided by a telecommunication terminal separate from the communication terminal and adapted to facilitate telecommunication services via the telecommunication network.

11. The communication terminal of claim 1 wherein the control system is further adapted to provide the telecommunication client, such that the at least one communication interface provides access to the web services network for the web client and access to the telecommunication network for the telecommunication client.

12. The communication terminal of claim 11 wherein the telecommunication client is further adapted to access at least a portion of the telecommunication information from the telecommunication network.

13. The method of claim 1 wherein the telecommunication service involves the telecommunication client.

14. A method comprising:
receiving telecommunication information via a web services network from a web client in association with a web service, which requires the telecommunication information to use a telecommunication service provided by a telecommunication network, the telecommunication information provided to the web client from an associated telecommunication client; and
initiating the telecommunication service to be provided by the telecommunication network via the web services network.

15. The method of claim 14 wherein the telecommunication information is associated with the telecommunication network and is specific to a user or a communication client associated with the user.

16. The method of claim 15 wherein the telecommunication information comprises address indicia associated with the communication client.

17. The communication terminal of claim 16 wherein the address indicia is a telecommunication identifier for applications supported by the telecommunication network.

18. The method of claim 14 further comprising requesting the telecommunication information from the web client.

19. The method of claim 14 wherein the telecommunication service is at least one of the group consisting of establishing telecommunication, authentication, policy enforcement, and billing.

20. A communication terminal comprising:
a user interface;
at least one communication interface; and
a control system associated with the user interface and the at least one communication interface and providing a telecommunication client adapted to:
interact with a telecommunication network to support telecommunications;
send telecommunication information to a web client, which interacts with a web server to invoke web services via a web services network and provides the telecommunication information to the web server in association with a web service, which requires the telecommunication information to use a telecommunication service provided by a telecommunication network.

21. The communication terminal of claim 20 wherein the telecommunication information bears on credentials of the telecommunication client or telecommunication network.

22. A communication terminal comprising:
a user interface;
at least one communication interface; and
a control system associated with the user interface and the at least one communication interface and providing a telecommunication client adapted to:
interact with a telecommunication network to invoke telecommunication services;
receive web services information from a web client; and
provide the web services information to the telecommunication network in association with a telecommunication service, which requires the web services information to use a web service provided by a web services network.
